(19) United States
(12) Patent Application Publication
(10) Pub. No.: US 2026/0291360 A1
(43) Pub. Date: Sep. 24, 2026

(54) VOLTAGE REGULATOR FAST TRANSIENT RESPONSE USING LOAD FOLLOWER CONTROL METHODOLOGY

(71) Applicant: Apple Inc., Cupertino, CA (US)

(72) Inventor: Vijay G. Phadke, San Jose, CA (US)

(21) Appl. No.: 19/082,672

(22) Filed: Mar. 18, 2025

(51) Int. Cl. H02M 1/00; H02M 3/00; H02M 3/158

(52) U.S. Cl. CPC H02M 1/0009; H02M 3/01; H02M 3/158

(57) ABSTRACT

An electrical system can include a switching regulator that delivers a regulated voltage to a system load via an interconnect impedance. The switching regulator can include an inner control loop that regulates an output current of the switching regulator based on a received current command, the received current command determined responsive in part to a load current sensed at the system load downstream of the interconnect impedance; and an outer control loop that regulates an output voltage of the switching regulator by providing a contribution to the current command, wherein the contribution to the current command provided by the outer control loop during a transient load is smaller than a portion of the current command responsive to the load current sensed at the system load downstream of the interconnect impedance.

### BACKGROUND

Computer processors (CPUs, GPUs, etc.) demand tight voltage regulation, low ripple, and fast transient response from the voltage regulator(s) that powers them. The processing power is continuously increasing, and the latest computing requirements may force processors to draw current at extremely fast slew rates. Current slew rates of several thousand amperes per micro-second are not uncommon. This can necessitate the use of buck (or other topology) voltage regulators that provide the power to processors to use very low inductor values, high switching frequencies, and ultra-high control loop bandwidth. Operation at such high frequencies can cause higher switching losses, adversely affecting operating efficiency. Further, even with such advanced regulators, the interconnect impedance of PCB traces can pose challenges to keeping voltage overshoot and undershoot within limits, whether at the voltage regulator and/or at the point of load. In some cases, this can cause designers to place the voltage regulators right under the processor, or even co-packaged in the silicon chip, which can result in significant cost premiums and other potential issues.

### SUMMARY

Thus, it may be desirable to provide voltage regulator/power converter circuits that can provide fast transient response while reducing the number and/or size of bulk capacitors required.

An electrical system can include a switching regulator that delivers a regulated voltage to a system load via an interconnect impedance. The switching regulator can include an inner control loop that regulates an output current of the switching regulator based on a received current command, the received current command determined responsive in part to a load current sensed at the system load downstream of the interconnect impedance; and an outer control loop that regulates an output voltage of the switching regulator by providing a contribution to the current command, wherein the contribution to the current command provided by the outer control loop during a transient load is smaller than a portion of the current command responsive to the load current sensed at the system load downstream of the interconnect impedance.

The portion of the current command responsive to the load current sensed at the system load downstream of the interconnect impedance can be a significant portion of the current command. The output current of the switching regulator can be an average output current. The output current of the switching regulator can be a peak output current. The load current sensed at the system load downstream of the interconnect impedance can be sensed downstream of a load capacitor provided at the system load. The inner control loop can have a bandwidth at least one decade higher than a bandwidth of the outer control loop. The switching regulator can include a buck converter. The switching regulator can include an LLC resonant converter.

A switching voltage regulator can include a buck converter that receives an input voltage and produces a regulated output voltage, the regulated output voltage being adapted to be delivered to a system load via an interconnect impedance; an inner control loop that regulates an average output current of the buck converter responsive to a difference between a command received from a current sensor located at the system load downstream of the interconnect impedance and an inductor current of the buck converter; and an outer control loop that regulates an output voltage of the buck converter by providing a contribution to the current command, wherein the contribution to the current command provided by the outer control loop during a transient load is smaller than a portion of the current command responsive to the load current sensed at the system load downstream of the interconnect impedance.

The portion of the current command responsive to the load current sensed at the system load downstream of the interconnect impedance can be a significant portion of the current command. The load current sensed at the system load downstream of the interconnect impedance can be sensed downstream of a load capacitor provided at the system load. The inner control loop can have a bandwidth at least one decade higher than a bandwidth of the outer control loop. The inductor current of the buck converter can be provided by a current sensor within the buck converter.

A switching voltage regulator can include a storage-inductor-less converter that receives an input voltage and produces a regulated output voltage, the regulated output voltage being adapted to be delivered to a system load via an interconnect impedance; an inner control loop that regulates an output current of the storage-inductor-less converter responsive to a difference between a command received from a current sensor located at the system load downstream of the interconnect impedance and an output current of the storage-inductor-less converter; and an outer control loop that regulates an output voltage of the storage-inductor-less converter by providing a contribution to the current command, wherein the contribution to the current command provided by the outer control loop during a transient load is smaller than a portion of the current command responsive to the load current sensed at the system load downstream of the interconnect impedance.

The storage-inductor-less converter can be an LLC resonant converter. An input of the storage-inductor-less converter can be galvanically isolated from an output of the storage-inductor-less converter. The portion of the current command responsive to the load current sensed at the system load downstream of the interconnect impedance can be a significant portion of the current command. The load current sensed at the system load downstream of the interconnect impedance can be sensed downstream of a load capacitor provided at the system load. The inner control loop can have a bandwidth at least one decade higher than a bandwidth of the outer control loop. The output current of the storage-inductor-less converter can be provided by a current sensor at an output of the storage-inductor-less converter.

### BRIEF DESCRIPTION OF THE DRAWINGS

FIG. 1 illustrates a buck voltage regulator.

FIG. 2 illustrates a buck voltage regulator using average current control.

FIG. 3 illustrates steady state operation of a buck voltage regulator and transient operation of a buck voltage regulator responsive to load changes.

FIG. 4 illustrates a buck voltage regulator with load follower control.

FIG. 5 illustrates an “inductor-less” voltage regulator with load follower control.

FIG. 6 illustrates an LLC converter with load follower control.

### DETAILED DESCRIPTION

In the following description, for purposes of explanation, numerous specific details are set forth to provide a thorough understanding of the disclosed concepts. As part of this description, some of this disclosure’s drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

A switching voltage regulator can be a power converter that draws power from a DC voltage source and delivers power to the load at a different DC output voltage level. These are sometimes called DC-DC converters. Such regulators can employ an inductive element to first generate an alternating current at the switching frequency of the regulator and then employ a capacitive filter to smooth it into a clean DC output, i.e., the regulated output voltage. In some cases, the input voltage source may be loosely regulated or unregulated, while the output of such a regulator may be tightly regulated. The output DC voltage can be lower or higher than the input DC voltage. Some voltage regulators can provide galvanic isolation, while others may not. Some voltage regulators may invert the polarity of the input voltage, such as providing negative output voltage with respect to ground when the input source has a positive voltage with respect to ground. A few examples of such converters include flyback converters, forward converters, resonant converters, buck converters, boost converters, buck-boost converters, and various derivatives of such topologies. The principles discussed herein are applicable to all such voltage regulators/DC- DC converters.

In many applications, the above-described voltage regulator can employ one or more capacitors as an output filter. The powered system (load) can employ one or more additional capacitors at or near the load point. The voltage regulator can be connected to the load by wires, printed circuit board (PCB) traces, connectors, bus bars, etc. The end result is that the connection between voltage regulator and load exhibits a non-zero impedance.

When the load demands tightly regulated voltage over wide range of load current, interconnection impedance can become important, potentially more so when the load draws current at very high slew rates and/or large amplitudes. One such example of such a load is computer processors, such as CPUs or GPUs. Computer processors can draw large step loads at very high slew rates and can also dump the load rapidly. The inductance of the interconnections between voltage regulator and such loads may not allow the voltage regulator to respond to the demand of the load sufficiently quickly. In these applications, local capacitors located near the load can provide instantaneous power to the system until the voltage regulator can meet the new demand after some (typically short) time period. Such slower response from the voltage regulator can sometimes require large storage capacitors on the load side and/or on the voltage regulator side.

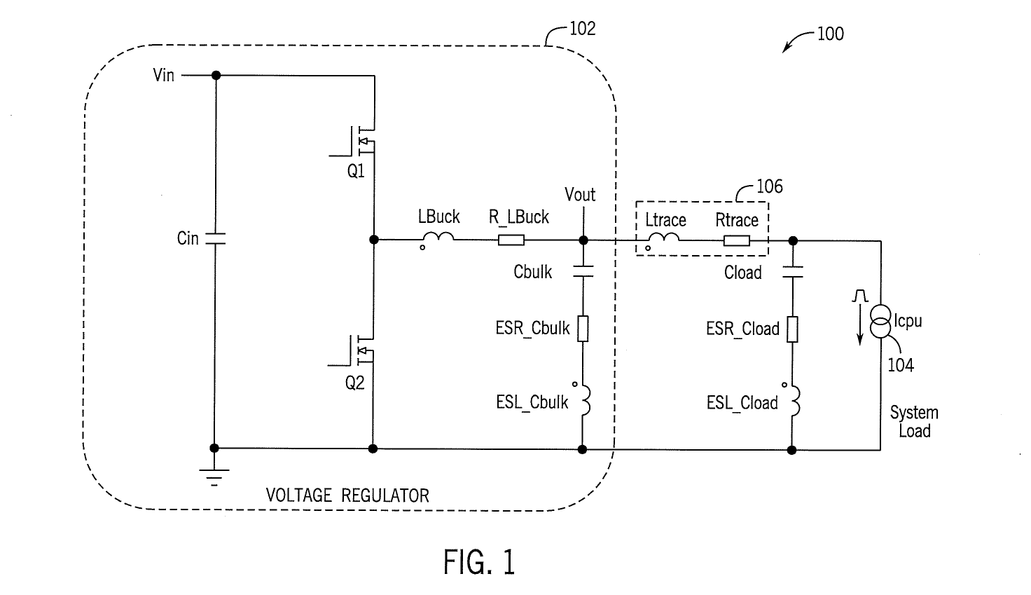

An example of such a system 100 employing a buck voltage regulator is shown in FIG. 1. Buck voltage regulator 102 provides power to load 104. Buck voltage regulator 102 receives an input voltage Vin and produces an output voltage Vout. Buck regulator output voltage Vout can be provided to load 104 via interconnect 106, the impedance of which is represented by inductance Ltrace and resistance Rtrace. As described above, this interconnect can be PCB traces, wires, bus bars, or other interconnect structures. Inductance Ltrace and resistance Rtrace are not discrete physical components, but rather a circuit model of the interconnect impedance. Also depicted in FIG. 1 are the output bulk capacitor of the voltage regulator (Cbulk) and a capacitor (or capacitors) Cload, which can be located near the load 104. These capacitors also have an equivalent series resistance (ESR) and equivalent series inductance (ESL), also depicted in FIG. 1, although, again, these are not discrete devices, but rather circuit model representations of the non-ideal physical properties of real capacitors.

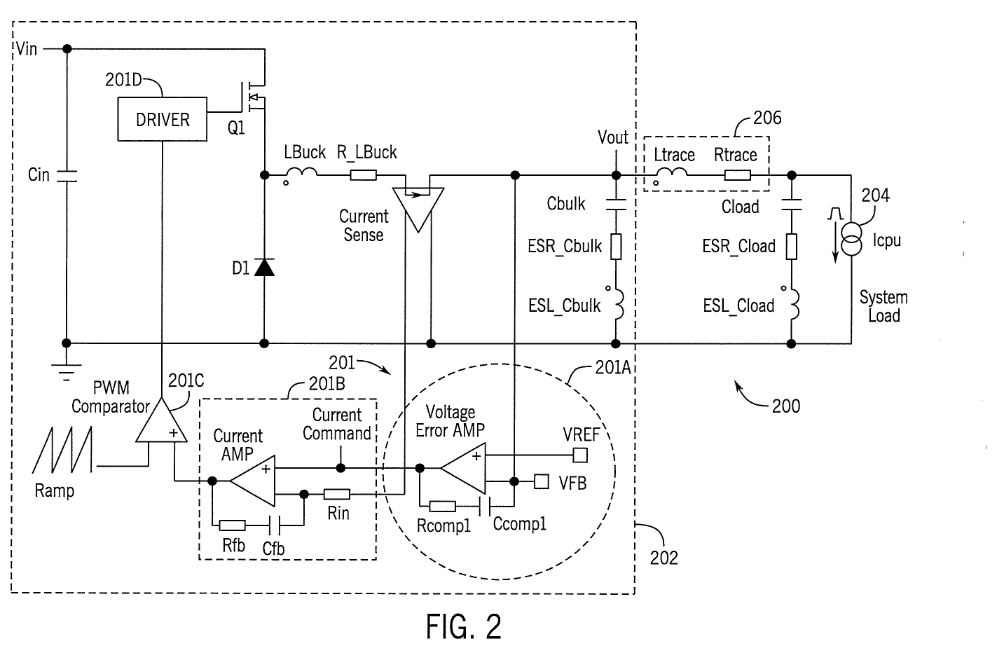

When load demand steps up or down, the surplus energy can be supplied or absorbed by the local capacitance Cload, while the current ramp up or ramp down by the voltage regulator may be delayed by the interconnect impedances, Ltrace and Rtrace. In some applications, maintaining voltage within acceptable regulation limits may require substantial load capacitance. Further, the response of the buck regulator to the load change may be slower due to the way conventional control loops for such regulators are designed. This is explained in greater detail below with reference to FIG. 2.

FIG. 2 illustrates a system 200 including a buck regulator 202 designed using average current mode control. Average current mode control can employ control circuitry 201 implementing an outer loop 201a and an inner loop 201b. Outer loop 201a can compare the regulator output voltage Vout with a fixed reference VREF and generate an error signal for achieving voltage regulation. This error signal can provide the reference for the inner loop 201a, which can be designed to regulate the average current in the buck inductor Lbuck by controlling switching of buck switch Q1 via PWM comparator 201c and driver circuitry 201d. Such PWM control techniques are known to those skilled in the art, and thus operational details will not be repeated here. To summarize, the control system controls the average inductor current to achieve the desired regulated output voltage.

When load 204 draws transient current at high slew rate, initial energy can be supplied by the local capacitance Cload, because buck voltage regulator 202 cannot support this demand instantaneously due to interconnect impedance 206 (Ltrace/Rtrace, particularly interconnect inductance Ltrace). After supplying this initial energy demand, the voltage across load capacitance Cload may drop, which can create a difference in voltage between the load capacitance Cload and output capacitance Cbulk of buck voltage regulator 202. This voltage difference appearing across Ltrace can allow ramping up of the current from voltage regulator. Then, buck voltage regulator 202 can start to deliver more current than what was programmed by its outer voltage regulation loop 201a. This, in turn, can cause a dip in its output voltage, causing increased error for the outer loop 201a voltage error amplifier. The inductor current command level can then be increased to bring the output voltage Vout back to regulation level, and steady state at the higher load current can be established.

Conversely, when the system load drops while the buck inductor Lbuck is delivering higher current, the excess current can be diverted into the output capacitance of the regulator (Cbulk) as well as the load inductance Cload. This additional energy stored in the capacitances can cause output voltage Vout to overshoot. This voltage overshoot can be sensed by the voltage error amplifier of outer loop 201a, causing an error signal that reduces the inductor current command level. After this correction, steady state at the lower current level can be achieved.

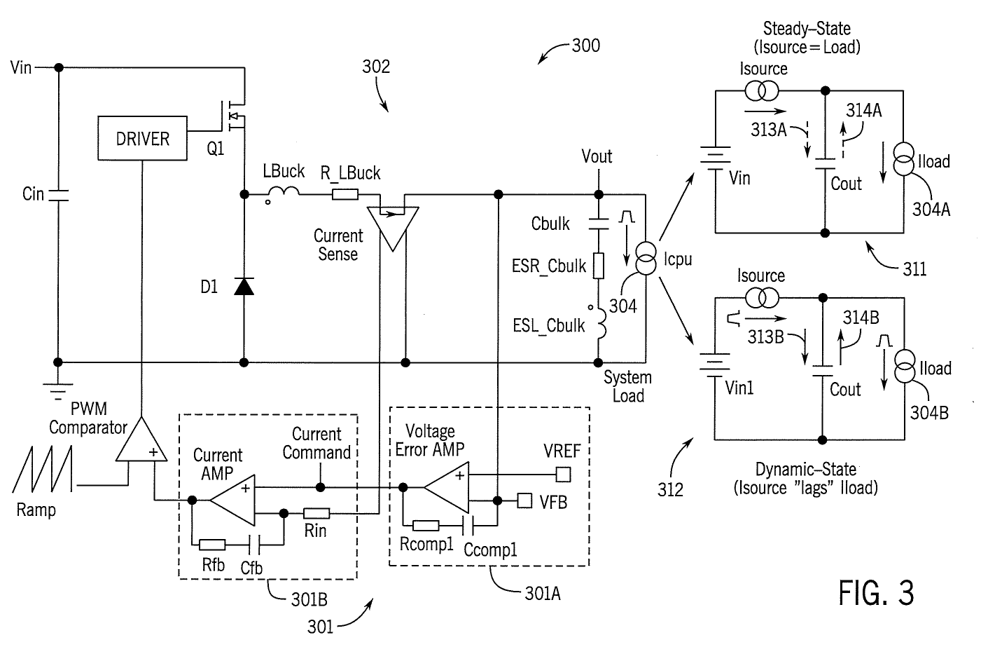

In a steady state of operation, average buck inductor current will be equal to the average output current of the buck voltage regulator 202. So, the buck voltage regulator behaves as a current source, and output filter capacitors (Cbulk, Cout) can be used to reduce ripple and support fast transient load demands. As is known to those skilled in the art, there are certain fundamental properties of circuits containing reactive components (inductors or capacitors). For example: in an inductive circuit, voltage leads current; in a capacitive circuit, current leads the voltage. Because the output of the buck voltage regulator is capacitive, when load demand steps up, current is first supplied by the capacitor, while voltage dip is seen later. (“Current leads voltage.”) Likewise, for the inductive interconnect circuit, voltage must drop across the interconnect inductance Ltrace before current ramps up from the voltage regulator. (“Voltage leads current.”) This principle can be applied to the buck voltage regulator system of FIGS. 1 and 2 as illustrated in FIG. 3 below.

FIG. 3 illustrates a buck voltage regulator system 300 as described above. Buck regulator system 300 can include buck voltage regulator 302, which can include control circuitry 301 similar to that described above. Buck voltage regulator 302 can deliver power to a system load 304 via an interconnection (not shown). Thus, what the control circuitry 301 achieves is to make average inductor current through the buck inductor Lbuck equal to the load current Iload, and the outer voltage loop 301a is only the “middleman” to communicate such need to the current control loop 301b.

As a result, at steady state (depicted by load circuitry schematic 311), the load current Iload is on average equal to the regulator output current Isource, and the net current into (313a) and out of (314a) the output capacitance Cout is zero. Conversely, during a load transient, the output capacitance Cout will either sink excess current 313a delivered to the load by the regulator in response to a load decrease or will source excess current 313b required by the load until the regulator can respond. This sinking or sourcing of current will correspondingly change the voltage across output capacitance Cout and thus change the regulated output voltage seen by the load. In other words, a perturbation of the regulated output voltage must happen first before the correction is made by the regulator control circuitry. In this case, perturbation means voltage overshoot or undershoot at the regulator output. Control strategies that could minimize this perturbation by reducing the role of the “middleman” performed by the outer voltage loop 301a in the converter response time are therefore desirable. Such control strategies can speed up the correction of average output current of the converter to match the load demand.

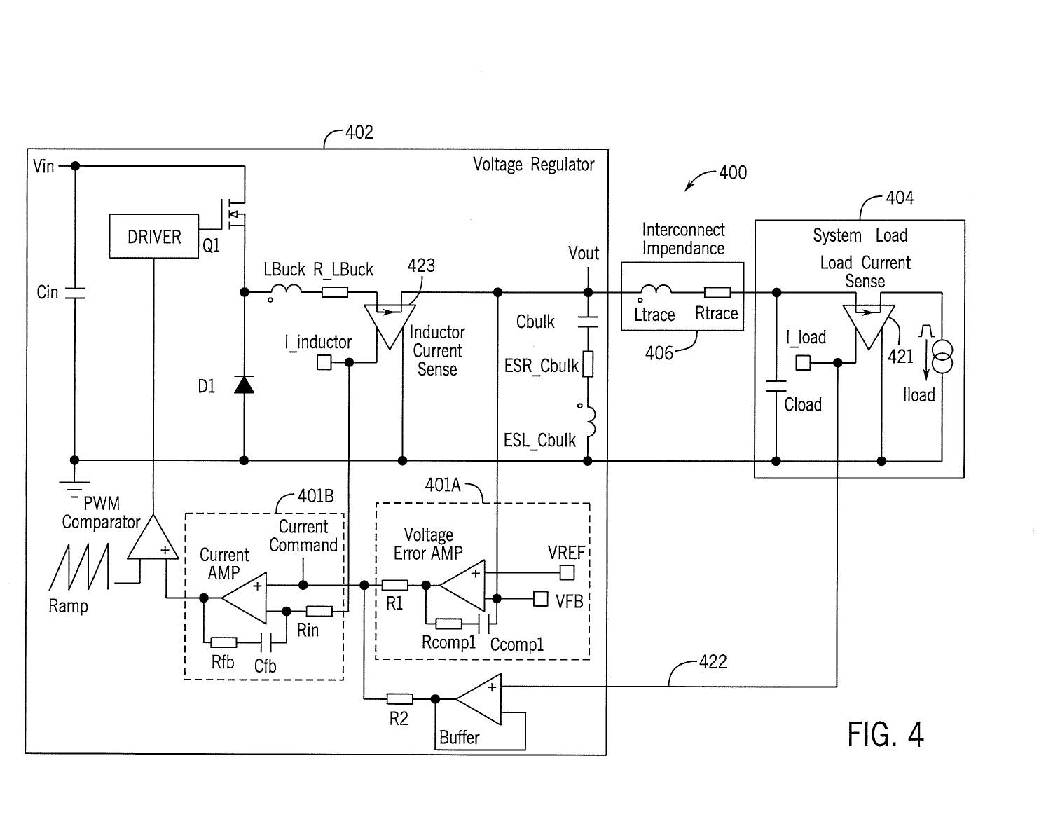

FIG. 4 shows an embodiment 400 of a “load follower” control technique that can address at least some of the issues described above. FIG. 4 depicts a buck voltage regulator 402 that supplies a load 404 via an interconnect impedance 406, as was described above. Buck voltage regulator 402 can employ a two-loop control system based on that described above. Inner loop 401b can regulate the average output current of the buck regulator, while outer loop 401a can be used for voltage regulation. One difference between the system of FIG. 4 and conventional average current mode control described above is that, in the proposed system, the reference for the inner current regulation loop 401b comes directly from the system load current. That is, a current sensor 421 senses the load current and provides an I_load output signal, corresponding to the actual load current Iload, to the current error amplifier directly via path 422. This path may include various other components, such as buffer amplifiers, etc. In fact, while the control circuitry described herein is described in terms of analog control loops, the techniques can be implemented using any combination of analog, digital, and/or programmable circuitry, which can use discrete components, integrated circuits, or any combination thereof. As a result, outer voltage loop 401a only adds or subtracts the error required to achieve the voltage regulation. Thus, the role of the outer voltage regulation loop as “middleman” can be reduced.

This can be explained through an example. Assume the same scale is used for sensing inductor current in the voltage regulator and load current in the system. This scaling can be defined as the signal amplitude in terms of “volts per ampere.” Also, if it is assumed that both sensors are perfect, then there is no error in sensing. In such a case, outer voltage regulation loop 401a will not have any role at all. The buck regulator 402 acts as a current regulator and follows the load current as the effective load resistance changes based on system power draw. The energy stored in the output capacitor of the regulator provides adequate energy storage to compensate for the delay in the control loop. Output voltage will just depend upon the load resistance.

However, in any practical system there will always be some error in sensed signal, even if the intent is to use the same scale. In such a case, the outer voltage regulation loop 401a can add or subtract the required difference to the current command that feeds the inner current loop 401b. As one non-limiting example, voltage regulator 402 can operate at input voltage (Vin) of 12V, deliver an output voltage (Vout) of 3.3V, and can be rated to deliver 25A of output current. The converter as well as load current sensors can be configured to deliver a current sense signal of 100mV per ampere. Further, assume that load current sensor 421 has +5% error, and inductor current sensor 423 also has -5% error. Thus, when the system load draws 25A current, the load current sensor will provide a signal of 2.625V instead of 2.5V due to +5% error. This directly commands the inner current loop, but the inductor current sense will give a current sense signal of 2.375V at 25A due to -5% error. In the absence of outer voltage regulation loop 401a, the control circuitry will increase the duty cycle of main switch Q1 such that inductor current sense signal reaches the commanded level of 2.625V. Thus, the converter will deliver excessive current of 27.63A due to mismatched scales and error of the two control signal inputs. This excessive current will cause the output voltage to increase beyond the regulation level set by VREF for the voltage error amplifier of outer control loop 401a. This error can cause the output of the voltage error amplifier to go lower than 2.625V, such that it sets the appropriate current reference to the inner current loop 401b due to the voltage divider action of resistors R1 and R2. If above scenario is reversed, then the output voltage of the voltage error amplifier will go higher to correct the current command level to achieve voltage regulation.

During dynamic loading conditions, the current command level of the inner current loop 401b can change rapidly, as a large portion of it is directly set by the load current sensor signal. This larger portion does not need to go through the slower speed of the outer voltage loop 401a. Thus, the slower output voltage loop 401a need only contribute a smaller portion of the difference. In some applications, it may be possible to achieve +/-2% or even better accuracy for the current sense signals using well-established methods. This means that in some cases >96% of the load transient correction can be done nearly instantaneously, while only 4% trimming will need to be done at a slower rate by the outer voltage loop 401a. Nonetheless, the principles described herein can be beneficial when any significant portion (e.g., >80%) of the current command/load transient correction occurs nearly instantaneously. As a result, the duty cycle of the buck regulator main switch Q1 can be increased or decreased rapidly without going through the slower outer voltage loop 401a to achieve most of the correction. The energy storage in the output capacitors can thus be used mainly to compensate for the error difference and delays in current sensors. This can allow for significant reduction in the capacitance used in the system, i.e., output capacitance Cbulk. This can save both cost as well as space in such systems.

To summarize, a switching voltage regulator implementing the techniques described herein can have three characteristics:

An inner control loop that can regulate the average output current of the switching voltage regulator based on a current command it receives;

Load current feedback sensed after the load capacitors to set a major portion of the current command of the inner loop; and

An outer control loop that can regulate the output voltage of the switching voltage regulator at a desired level by making a minor contribution to the current command of inner control loop.

It should be noted that the inner control loop regulates the average output current. In topologies that employ an output inductor, average inductor current is effectively the same as average output current of the voltage regulator. Thus, the inner control loop in such topologies can be set to directly control the average inductor current as described with reference to FIGS. 3 and 4. Alternately, the inner loop can control the peak (rather than average) inductor current, which indirectly controls the average current. These cases represent control methods that employ “current mode control” methods.

If the switching voltage regulator employs voltage mode control, a voltage error amplifier can generate the error signal which can be compared to a ramp to control duty cycle of the main switch/inductor. To use the principles described above with such systems, When the proposed invention is used with such converters, the inner loop can regulate average output current of the switching voltage regulator by sensing the current after output bulk capacitance (rather than after any load-side capacitance).

Those skilled in the art know that when two control loops are cascaded as described herein, the respective bandwidths of the two control loops need to be separated (preferably by at least one decade, i.e., a bandwidth ratio of at least 10x) to avoid potential interaction. To achieve this, the inner control loop that regulates the average output current of the converter can have a higher bandwidth, while the outer voltage control loop can have a lower bandwidth separated at least by one decade from the inner control loop bandwidth.

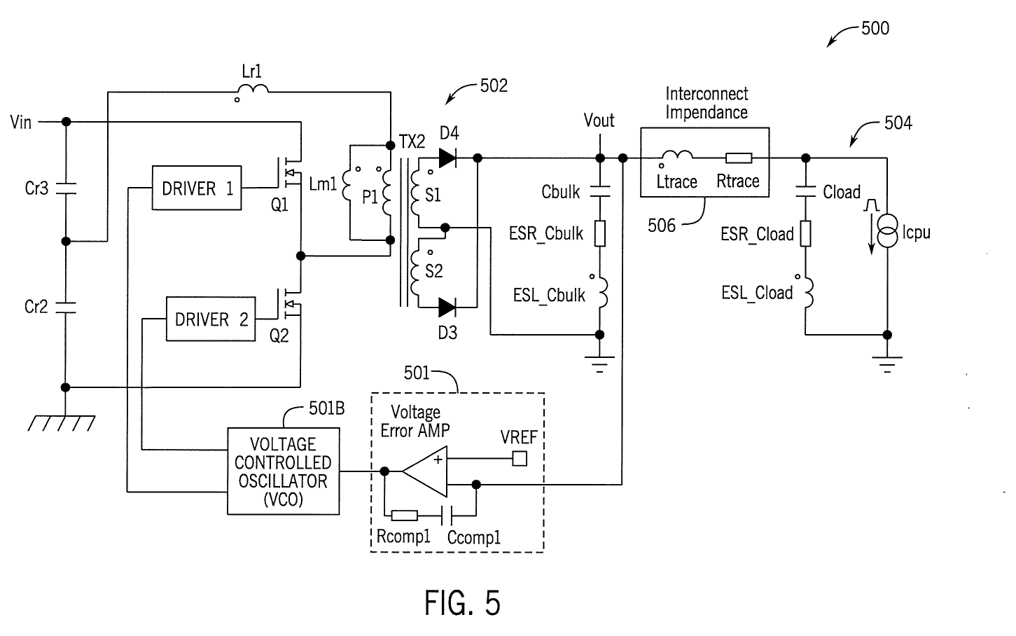

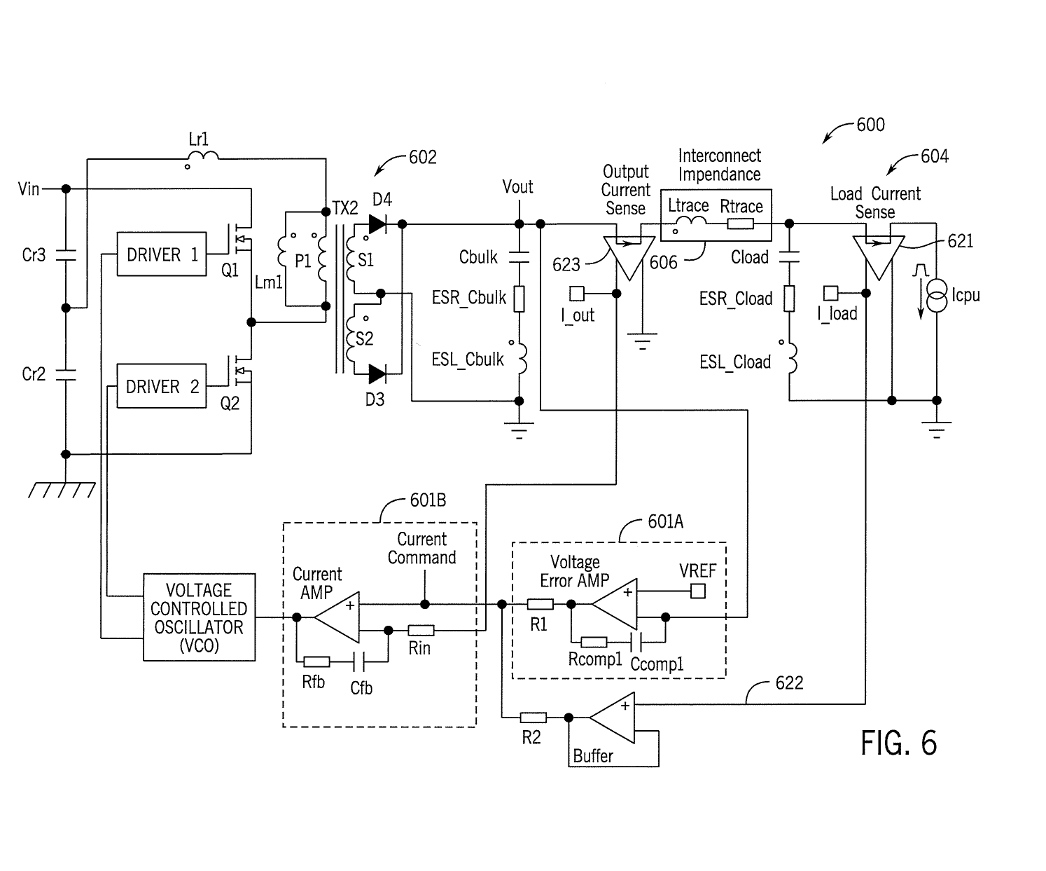

FIGS. 5 and 6 illustrate a system 500 including an “inductor-less” or “storage-inductor-less” voltage converter operating as per the principles described herein to supply power to a load 504 via an interconnect 506. FIG. 5 shows an LLC resonant converter 502, which employs a transformer TX2. The transformer provides galvanic isolation between input and output and also allows stepping the input voltage up or down as per the application requirement. Such a converter (regulator) can employs variable frequency operation. A voltage regulation loop 501 can compare the output voltage with a fixed reference VREF) and can provide an error output. The error output can be used to drive a voltage-controlled oscillator (VCO) 501b. Primary side power switches Q1 and Q2 can be driven at nearly 50% duty cycle and 180 degrees output phase. Nearly, in this sense, means that there is a short dead time between turning on one switch and turning off the complementary switch to prevent cross-conduction or short circuiting the input.

The operating frequency can decrease as the output power increases. The inductor Lr1 shown in FIG. 5 is not an energy storage inductor (as in the buck converter example described above) but a resonant inductor. Thus, “inductor-less” does not mean that the system is literally without any inductors, but rather that it lacks a discrete inductor for energy storage, as in the buck example, or is “storage-inductor-less.” To achieve galvanic isolation, the error signal can be transmitted through an optocoupler, not shown in FIG. 5 for simplicity. Detailed operation of an LLC converter is beyond the scope of this discussion and thus omitted for clarity. However, it can be appreciated that the illustrated LLC converter is not immune to the above-discussed deficiencies of the buck converter in responding to load transients. More specifically, when the system applies large step loads, the change in current delivered by the converter can be delayed because of the presence of the interconnect inductance 506 (Ltrace). The short-term energy is supplied (or absorbed) by the output capacitor Cload, and the output voltage must undershoot or overshoot for the voltage control loop 501 to notice the change in load demand and make the required correction.

FIG. 6 illustrates an implementation 600 of an LLC converter switching regulator 602 that implements the load follower control techniques described above to supply power to a load 604 via an interconnect impedance 606. As above, inner control loop 601b can regulate the average current delivered by the LLC regulator 602. In this case, output current sensor 623 can be located after the output bulk capacitor(s) Cbulk of the LLC converter. As in the example described above, a majority of the current command level can be directly set by the current sense signal delivered from load current sensor 621 via path 622, with minor contribution is made by the outer voltage regulation loop 601a. In most respects, the system operates as described with respect to the buck voltage regulator embodiment described above.

Thus, for a variety of switching converter/regulator topologies, including those enumerated above, the described load follower control technique can give a head start to the switching regulator to increase or decrease the supplied current more quickly than some other control strategies. Conversely, in many conventional control strategies, such response can be delayed due to the parasitic interconnect impedance as well as size of the output capacitance. In at least some embodiments, it may be desirable that, the current sense signal gain for sensing the output current of the voltage regulator (e.g., the current gain of current sensor 423/623) and the current sense signal gain for sensing the load current (e.g., the current gain of current sensor 421/621) are normalized by setting them equal. As briefly mentioned above, any errors or nonlinearity in current sensing elements can be compensated by the outer voltage control loop 401a/601a. Reducing such errors can improve the response time as the outer loop contribution can be substantially smaller than the inner current loop contribution.

Some computer systems may employ several power conversion stages in series/cascaded. For example, a front-end AC/DC power supply may draw power from utility wall output and provide power at 12V DC. This 12V DC bus may be further converted to a 4V bus, and then an additional power stage may further convert it into sub-1V level, such as might be required by the computer processor. Traditionally in such a distributed power architecture, each converter might use voltage and current feedback from its own input or output. However, using the principles described herein, each converter can use current feedback from a succeeding power stage to respond much faster, at least partially mitigating effects of the interconnect impedances.

The foregoing describes exemplary embodiments of load follower control systems for switching voltage regulators. Such configurations may be used in a variety of applications but may be particularly advantageous when used in conjunction with power supplies for computer processing systems and similar applications requiring fast transient response. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. An electrical system including a switching regulator that delivers a regulated voltage to a system load via an interconnect impedance, the switching regulator comprising:
an inner control loop that regulates an output current of the switching regulator based on a received current command, the received current command determined responsive in part to a load current sensed at the system load downstream of the interconnect impedance; and
an outer control loop that regulates an output voltage of the switching regulator by providing a contribution to the current command, wherein the contribution to the current command provided by the outer control loop during a transient load is smaller than a portion of the current command responsive to the load current sensed at the system load downstream of the interconnect impedance.

2. The electrical system of claim 1 wherein the portion of the current command responsive to the load current sensed at the system load downstream of the interconnect impedance is a significant portion of the current command.

3. The electrical system of claim 1 wherein output current of the switching regulator is an average output current.

4. The electrical system of claim 1 wherein the output current of the switching regulator is a peak output current.

5. The electrical system of claim 1 wherein the load current sensed at the system load downstream of the interconnect impedance is sensed downstream of a load capacitor provided at the system load.

6. The electrical system of claim 1 wherein the inner control loop has a bandwidth at least one decade higher than a bandwidth of the outer control loop.

7. The electrical system of claim 1 wherein the switching regulator comprises a buck converter.

8. The electrical system of claim 1 wherein the switching regulator comprises an LLC resonant converter.

9. A switching voltage regulator comprising:
a buck converter that receives an input voltage and produces a regulated output voltage, the regulated output voltage being adapted to be delivered to a system load via an interconnect impedance;
an inner control loop that regulates an average output current of the buck converter responsive to a difference between a command received from a current sensor located at the system load downstream of the interconnect impedance and an inductor current of the buck converter; and
an outer control loop that regulates an output voltage of the buck converter by providing a contribution to the current command, wherein the contribution to the current command provided by the outer control loop during a transient load is smaller than a portion of the current command responsive to the load current sensed at the system load downstream of the interconnect impedance.

10. The switching voltage regulator of claim 9 wherein the portion of the current command responsive to the load current sensed at the system load downstream of the interconnect impedance is a significant portion of the current command.

11. The switching voltage regulator of claim 9 wherein the load current sensed at the system load downstream of the interconnect impedance is sensed downstream of a load capacitor provided at the system load.

12. The switching voltage regulator of claim 9 wherein the inner control loop has a bandwidth at least one decade higher than a bandwidth of the outer control loop.

13. The switching voltage regulator of claim 9 wherein the inductor current of the buck converter is provided by a current sensor within the buck converter.

14. A switching voltage regulator comprising:
a storage-inductor-less converter that receives an input voltage and produces a regulated output voltage, the regulated output voltage being adapted to be delivered to a system load via an interconnect impedance;
an inner control loop that regulates an output current of the storage-inductor-less converter responsive to a difference between a command received from a current sensor located at the system load downstream of the interconnect impedance and an output current of the storage-inductor-less converter; and
an outer control loop that regulates an output voltage of the storage-inductor-less converter by providing a contribution to the current command, wherein the contribution to the current command provided by the outer control loop during a transient load is smaller than a portion of the current command responsive to the load current sensed at the system load downstream of the interconnect impedance.

15. The switching voltage regulator of claim 14 wherein the storage-inductor-less converter is an LLC resonant converter.

16. The switching voltage regulator of claim 14 wherein an input of the storage-inductor-less converter is galvanically isolated from an output of the storage-inductor-less converter.

17. The switching voltage regulator of claim 14 wherein the portion of the current command responsive to the load current sensed at the system load downstream of the interconnect impedance is a significant portion of the current command.

18. The switching voltage regulator of claim 14 wherein the load current sensed at the system load downstream of the interconnect impedance is sensed downstream of a load capacitor provided at the system load.

19. The switching voltage regulator of claim 14 wherein the inner control loop has a bandwidth at least one decade higher than a bandwidth of the outer control loop.

20. The switching voltage regulator of claim 14 wherein the output current of the storage-inductor-less converter is provided by a current sensor at an output of the storage-inductor-less converter.
